(19) United States
(12) Patent Application Publication
(10) Pub. No.: US 2026/0195805 A1
(43) Pub. Date: Jul. 9, 2026

(54) IMAGE DISPLAY, PROCESSING, UPLOADING, AND GENERATION METHOD, SYSTEM, AND ELECTRONIC DEVICE

(71) Applicant: Hangzhou Alibaba International Internet Industry Co., Ltd., Hangzhou City (CN)

(72) Inventor: Chenxing PAN, Hangzhou (CN)

(21) Appl. No.: 19/558,025

(22) Filed: Mar. 5, 2026

Related U.S. Application Data
(63) Continuation of application No. PCT/CN2024/105573, filed on Jul. 15, 2024.

(30) Foreign Application Priority Data
Sep. 11, 2023 (CN) 202311168286.X

(51) Int. Cl. G06Q 30/0601; G06T 11/60

(52) U.S. Cl. CPC G06Q 30/06431; G06T 11/60

(57) ABSTRACT

An image display method includes: in response to an operation of a user, obtaining a second image having a correlation with the user; where the second image is generated based on at least one decorative material and a first image of a target object, and the at least one decorative material has a correlation with the user; displaying the second image on a client interface. In the technical solution provided by the embodiments of the present application, the second image displayed to the user is a decorated image and has a correlation with the user; in this way, the user can directly feel that the target object is closely related to themselves, providing a stronger sense of immersion.

This application is a Continuation Application of International Patent Application No. PCT/CN2024/105573, filed on July 15, 2024, which is based on and claims priority to and benefits of Chinese Patent Application No. 202311168286.X, filed with the China National Intellectual Property Administration on September 11, 2023, and entitled "Image display, processing, uploading, and generation method, system, and electronic device." The entire content of the above referenced applications is incorporated in the present application by reference.

### TECHNICAL FIELD

The present application relates to the field of computer technology, and in particular, to a image display, processing, uploading, and generation method, system, and electronic device.

### BACKGROUND

Currently, product images displayed on e-commerce platforms are one of the main core elements of product information, and consumers often first learn about product content through product images. Most product images are taken by merchants themselves. Product images taken by merchants have relatively simple backgrounds, such as solid color backgrounds, outdoors, or indoors, which cannot attract users well.

### SUMMARY

The present application provides an image display, processing, uploading, and generation method, system, and electronic device to solve the above problems or at least partially solve the above problems.

In a first embodiment of the present application, an image display method is provided. The method includes:

in response to an operation of a user, obtaining a second image having a correlation with the user; where the second image is generated based on at least one decorative material and a first image of a target object, and the at least one decorative material has a correlation with the user;

displaying the second image on a client interface.

In a second embodiment of the present application, an image processing method is provided. The method includes:

obtaining a first image of a target object;

determining at least one decorative material suitable for the target object ;

generating a second image based on the at least one decorative material and the first image;

associating the second image with the target object for display when a user having a correlation with the at least one decorative material accesses the target object.

In a third embodiment of the present application, an image upload method is provided. The method includes:

in response to an image upload request, obtaining a first image of a target object;

determining at least one decorative material suitable for the target object ;

generating a second image based on the at least one decorative material and the first image;

displaying the second image for an uploader to review and confirm whether to upload;

where the second image is used for display when a user having a correlation with the at least one decorative material accesses the target object.

In a fourth embodiment of the present application, an image generation method is provided. The method includes:

triggering a preset analysis model using object information of a target object to determine at least one decorative material suitable for the target object;

using the first image of the target object and the at least one decorative material as drawing materials for a preset drawing model to generate a second image of the target object;

where the second image is used for display when a user having a correlation with the at least one decorative material accesses the target object.

In a fifth embodiment of the present application, a product image display method is provided. The method includes:

in response to an operation of a user, determining a target address;

obtaining a product image of a product based on the target address; where the product image is generated based on an original image of the product and a background material, and the background material is correlated with regional characteristics to which the target address belongs and characteristics of the product itself;

displaying the product image of the product on a webpage or application page corresponding to a region to which the target address belongs;

where the target address is selected by the user or located by a user client.

In a sixth embodiment of the present application, a product image processing method is provided. The method includes:

obtaining a sales region of a product;

determining a background material suitable for the product and having characteristics of the sales region according to the sales region;

generating a product image of the product displayed in a scene corresponding to the background material based on an original image of the product and the background material;

where the product image is used for display in a webpage or application page corresponding to the sales region.

In a seventh embodiment of the present application, an image display method is provided. The method includes:

determining a regional version of a target application;

determining at least one decorative material suitable for a target object and having characteristics of a covered area based on a coverage area of the regional version;

generating a second image of the target object according to a first image of the target object and the at least one decorative material;

where the second image is used for display when a user using the regional version application accesses the target object.

In an eighth embodiment of the present application, an image display system is provided. The system includes:

a first client, used for requesting to obtain a second image of a target object from a server in response to an operation of a user;

a server, used for obtaining a second image having a correlation with the user according to relevant information of the user, and sending the second image to the first client; where the second image is generated based on at least one decorative material and a first image of the target object, and the at least one decorative material has a correlation with the user;

the first client is further used for displaying the second image on a client interface.

In a ninth embodiment of the present application, an image processing system is provided. The system includes:

a second client, used for sending a first image of a target object to a server in response to an image upload request;

a server, used for determining at least one decorative material suitable for the target object, and generating a second image based on the at least one decorative material and the first image;

the second client is used for displaying the second image for an uploader to review and confirm whether to upload;

where the second image is used for display when a user having a correlation with the at least one decorative material accesses the target object.

In yet another embodiment of the present application, an electronic device is further provided. The electronic device includes: a memory and a processor, where the memory is used for storing a computer program; the processor is coupled to the memory and used for executing the computer program stored in the memory to implement the steps provided in the image display method embodiment of the present application, or the steps provided in the image processing method embodiment, or the steps in the image upload method embodiment, or the steps in the image generation method, or the steps in the product image display method embodiment, or the steps in the product image processing method embodiment.

The present application further provides a computer-readable storage medium embodiment. A computer program is stored on the computer-readable storage medium, and when the computer program is executed, the steps in the methods provided in the above embodiments can be implemented.

The present application further provides a computer program product. The computer program product includes a computer program or instructions, and when the computer program or instructions are executed by a processor, the processor is caused to execute the steps in the above methods.

A technical solution provided by an embodiment of the present application obtains a second image having a correlation with a user after monitoring an operation of the user, and displays the second image on a client interface; where the second image is generated based on at least one decorative material and a first image of the target object, and the at least one decorative material has a correlation with the user. It can be seen that the second image displayed to the user in this solution is a decorated image that has a correlation with the user; in this way, the user can directly feel that the target object is closely related to himself/herself, providing a stronger sense of immersion.

In another technical solution provided by an embodiment of the present application, at least one suitable decorative material is determined for a target object, and a second image is generated based on the at least one decorative material and a first image of the target object; the second image is associated with the target object, so that it can be displayed when a user having a correlation with the at least one decorative material accesses the target object. This solution pre-decorates the first image of the target object, generates a decorated second image and associates it with the target object to display it to the user when a correlated user accesses the target object, so that the user can directly feel that the target object is closely related to himself/herself, providing a stronger sense of immersion.

In yet another technical solution provided by an embodiment of the present application, after an uploader uploads a first image of a target object, at least one suitable decorative material can be automatically determined for the target object to generate a second image based on the at least one decorative material and the first image of the target object, allowing the uploader to review and confirm whether to upload. If the uploader reviews and confirms the upload, the second image can be displayed when a user having a correlation with the at least one decorative material accesses the target object on a corresponding platform application side. The entire process only requires the uploader to upload one first image of the target object without excessive participation, helping the uploader improve the correlation between the target object image and the user and gain more attention from users.

An embodiment of the present application further provides a technical solution that uses artificial intelligence technology to decorate a second image of a target object, so that the decorated second image has a certain correlation with an accessing user, improving the user's attention to the target object. That is, object information of the target object is used to trigger a preset analysis model to determine at least one decorative material suitable for the target object, and then the first image of the target object and the at least one decorative material are used as drawing materials for a preset drawing model to generate a second image of the target object; this improves image generation efficiency and is suitable for large-batch image processing tasks on a platform.

In yet another technical solution provided by an embodiment of the present application, a background material suitable for a product and having characteristics of a sales region is determined according to the sales region of the product; a product image of the product displayed in a scene corresponding to the background material is generated based on an original image of the product and the background material; the product image is used for display in a webpage or application page corresponding to the sales region. It can be seen that the embodiment of the present application provides another new idea where the same product has different product images for different sales regions, and carries local characteristics; in this way, after local users see the product image of the product in the webpage or application page corresponding to the sales region, they will feel it is closely related to themselves, providing a stronger sense of immersion. There is also a possibility that a user in a first sales region can view a product image of a product through a webpage or application page corresponding to a second sales region, so as to intuitively see a scene image of the user using the product in the second sales region after purchasing it in the first sales region, providing a strong sense of immersion. For example, a user is going to a seaside for vacation and checks long dresses suitable for seaside vacation at his/her residence before the vacation; at this time, the user can check product images of such products through a webpage or application page corresponding to the vacation region.

For a merchant, it is the sales region of the product. For a consumer (or user), it is a located address (or region) or an address (or region) selected by the user. Based on the above solution, in the technical solution provided by the embodiment of the present application, a product image of a product can be obtained based on a client located address or an address selected by a user after a user operation; then it is displayed on a webpage or application page corresponding to a region to which the address belongs.

### BRIEF DESCRIPTION OF THE DRAWINGS

FIG. 1a is a schematic diagram of a first image display system provided by an embodiment of the present application;

FIG. 1b is a schematic diagram of a second image display system provided by an embodiment of the present application;

FIG. 1c is a schematic diagram of a third image processing system provided by an embodiment of the present application;

FIG. 2 is a schematic flowchart of an image display method provided by an embodiment of the present application;

FIG. 3 is a schematic flowchart of an image processing method provided by an embodiment of the present application;

FIG. 4 and FIG. 5 are schematic principle diagrams of a merchant inputting a corresponding original image, object information, and the like for a product provided by an embodiment of the present application;

FIG. 6 is a schematic principle diagram of drawing a product image using a preset drawing model in an embodiment of the present application;

FIG. 7 illustrates a technical solution provided by an embodiment of the present application in the form of a signaling diagram;

FIG. 8 is a schematic flowchart of an image upload method provided by an embodiment of the present application;

FIG. 9a is a schematic flowchart of a product image processing method provided by an embodiment of the present application;

FIG. 9b is a schematic flowchart of a product image display method provided by an embodiment of the present application;

FIG. 10 is a schematic flowchart of an image generation method provided by an embodiment of the present application;

FIG. 11 is a structural block diagram of an image display device provided by an embodiment of the present application;

FIG. 12 is a structural block diagram of an image processing device provided by an embodiment of the present application;

FIG. 13 is a structural block diagram of an image generation device provided by an embodiment of the present application;

FIG. 14 is a structural block diagram of an electronic device provided by an embodiment of the present application.

### DETAILED DESCRIPTION OF EMBODIMENTS

Currently, most product images displayed on e-commerce platforms have relatively simple backgrounds, and image content lacks image content related to actual use of the product by consumers, so consumers cannot well feel the correlation between the product and themselves from the product images. To address this problem, the present application provides a technical solution capable of generating a product image having a correlation with a consumer based on an original image of a product uploaded by a merchant, and displaying the product image to a correlated consumer, so that the consumer can feel the product is closely related to himself/herself, which helps improve the consumer's attention to the product.

In order to enable those skilled in the art to better understand the solutions of the present application, the technical solutions in the embodiments of the present application will be clearly and completely described below in conjunction with the drawings in the embodiments of the present application.

In some processes described in the specification, claims, and the above drawings of the present application, multiple operations appearing in a specific order are included, and these operations may be performed not in the order in which they appear herein or performed in parallel. The serial numbers of operations such as 101, 102, etc., are only used to distinguish different operations, and the serial numbers themselves do not represent any execution order. In addition, these processes may include more or fewer operations, and these operations may be performed sequentially or in parallel. It should be noted that descriptions such as "first", "second", etc. herein are used to distinguish different messages, devices, modules, etc., and do not represent a sequential order, nor do they limit "first" and "second" to be different types. The term "or/and" in the present application is merely an association relationship describing associated objects, indicating that three relationships may exist, for example: A or/and B indicates three cases: A exists alone, A and B exist simultaneously, and B exists alone; the character "/" in the present application generally indicates that the preceding and following associated objects are in an "or" relationship. It should also be noted that the terms "comprising," "including," or any other variants thereof are intended to cover non-exclusive inclusion, so that a product or system including a series of elements includes not only those elements but also other elements not explicitly listed, or further includes elements inherent to such a product or system. Without further limitations, an element defined by the phrase "including a..." does not exclude the existence of other identical elements in the product or system including the element. In addition, the various embodiments described below are only some of the embodiments of the present application, rather than all of the embodiments. Based on the embodiments in the present application, all other embodiments obtained by those skilled in the art without creative effort shall fall within the protection scope of the present application.

Before introducing the solutions provided by the embodiments of the present application, some terms involved in the present application are first explained.

Image generation service is a functional service that uses artificial intelligence (AI) technology to automatically generate content, such as AICG (AI-Generated Content, using artificial intelligence technology to produce content), and more specifically, such as SD (Stable Diffusion). SD is an AI drawing tool that can be based on text-to-image (text2img) and image-to-image (img2img) , and can be called in batches through a Web UI interface (page) and API (Application Programming Interface) to achieve image generation. Among them, text-to-image refers to generating a corresponding image based on input text. Image-to-image refers to generating a new image based on input text and a reference image; specifically, the generated new image is obtained by modifying the input reference image according to the input text description.

The page corresponding to the above SD in the image-to-image mode can be seen in page B shown in FIG. 4. As seen in page B, the image-to-image functions of SD in the image-to-image mode mainly include but not limited to the following categories: inpaint, inpaint upload, and the like. Here, inpaint refers to only redrawing a specific area in the uploaded original image while ensuring other areas remain unchanged. Inpaint upload refers to only redrawing an area belonging to a mask identifier in the original image, and the mask can be prepared in other tools (such as Photoshop, etc.) and uploaded.

Basic parameters of image-to-image include but are not limited to the following: Resize mode, Mask blur degree, Masked content, Inpaint area, and the like. Here, the resize mode refers to the size adjustment method that needs to be selected when the size of the original image is different from the size of the image to be generated, mainly including just resize (referring to adjusting the image to the width and height set for image generation), crop and resize (referring to cropping the image to fit the width and height of the image generation), and the like. Mask blur is generally adjusted between 0 and 64. Mask modes include inpaint masked (referring to redrawing only in the mask area) and inpaint not masked. Masked content includes fill, original, and the like. For a more detailed introduction to the above basic parameters, reference may be made to existing content.

A natural language processing model driven by artificial intelligence technology, such as ChatGPT (Chat Generative Pre-trained Transformer, a chatbot), uses advanced artificial intelligence technology and natural language processing technology to understand and generate natural conversation content, can be used in various scenarios, such as customer service, entertainment, language learning, etc., and can provide high-quality, accurate, and natural language services.

Each method embodiment provided by the present application can be implemented on hardware corresponding to the image processing system described below. Specifically, in an embodiment, the image processing system includes: a first client and a server; where,

the first client is used for requesting to obtain a second image of a target object from the server in response to an operation of a user;

the server is used for obtaining a second image having a correlation with the user according to relevant information of the user, and sending the second image to the first client; where the second image is generated based on at least one decorative material and a first image of the target object, and the at least one decorative material has a correlation with the user;

the first client is further used for displaying the second image on a client interface.

The above image processing system may be an e-commerce system in the e-commerce field; correspondingly, the target object may be any object sold online through the e-commerce system, such as various products like clothes, shoes, bags, etc. Alternatively, the above image processing system can also be applied to the social field, such as social e-commerce, social knowledge payment, etc.

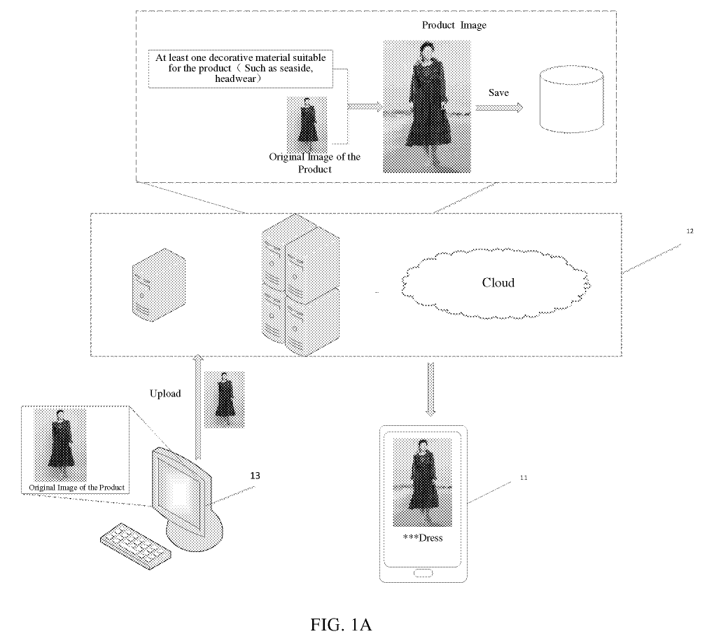

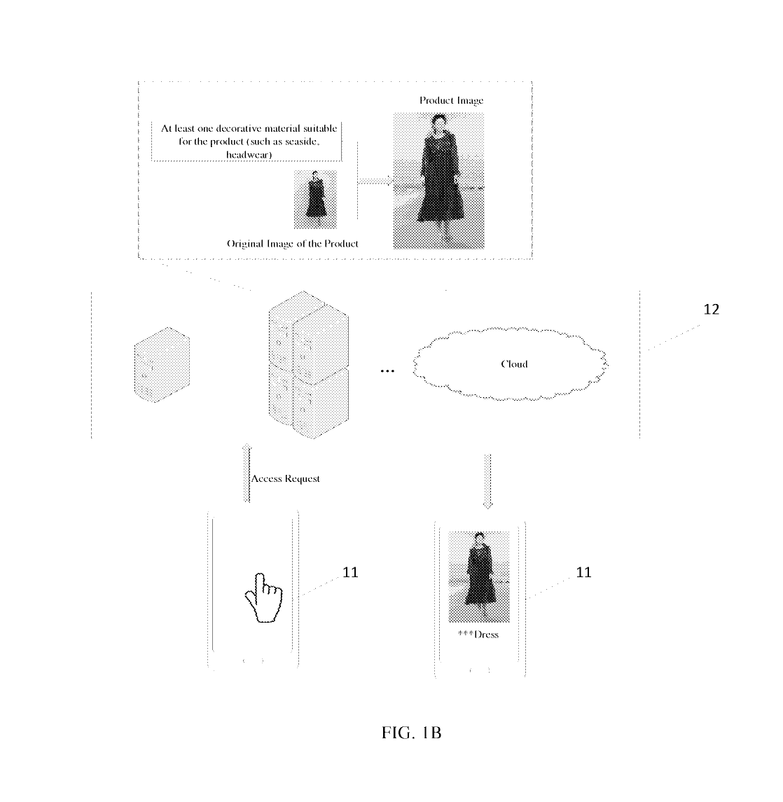

FIG. 1a and FIG. 1b illustrate examples of the image processing system provided by the present embodiment applied to the field of e-commerce.

Further, in another embodiment, the image processing system includes: a second client and a server; where,

the second client is used for sending a first image of a target object to the server in response to an image upload request;

the server is used for determining at least one decorative material suitable for the target object, and generating a second image based on the at least one decorative material and the first image;

the second client is used for displaying the second image for an uploader to review and confirm whether to upload;

where the second image is used for display when a user having a correlation with the at least one decorative material accesses the target object.

Similarly, the above image processing system may also be an e-commerce system in the e-commerce field; correspondingly, the target object may also be any object sold online through the e-commerce system, such as various products like clothes, shoes, bags, etc. The image uploader may be a merchant.

FIG. 1c illustrates an example of the image processing system provided by the present embodiment applied to the field of e-commerce.

The system embodiments provided by the present application are introduced below from the perspective that the above image processing system is an e-commerce system and the target object is a product.

Each method embodiment provided by the present application can be implemented on the hardware basis corresponding to the e-commerce system shown in FIG. 1a and FIG. 1b. As shown in FIG. 1a and FIG. 1b, the e-commerce system may include: a first client 11 and a server 12. The first client 11 can be understood as a client on the consumer (or user) side in the field of e-commerce.

The first client 11 is used for, in response to an operation of a user, requesting to obtain a product image of a product from the server 12.

The server 12 is used for, according to relevant information of the user, obtaining a product image of the product that has a correlation with the user, and sending the product image to the first client 11; where the product image is generated based on at least one decorative material and an original image of the product, and the at least one decorative material has a correlation with the user.

The first client 11 is used for displaying the product image on a client interface.

The above product image may be the second image mentioned in the above embodiments; the original image of the product may be the first image.

Here, the relevant information of the user may include but not limited to: a crowd type to which the user belongs, location information of the user, a season in a region where the user is located, a time period in the region where the user is located, a user preferred environment (indoor/outdoor), etc. It should be noted here that content involving user privacy in the relevant information of the user is obtained with the user's permission.

For example, in the scenario in FIG. 1a, the user is a young female, and the current location is in Hainan, etc.; the server obtains a product image of a young female model wearing a dress (product) at the seaside according to the relevant information of these users.

In a specific embodiment, the original image of the product is uploaded to a server 12 by a second client 13 corresponding to an e-commerce merchant, and the server 12 can determine at least one decorative material suitable for the product based on information provided by the merchant; then a product image is generated based on the at least one decorative material and the original image of the product, and the product image is associated with the product and stored. That is, the server performs the above steps when the e-commerce merchant uploads the original image of the product, pre-processing the product image to generate a decorated product image and storing it. That is to say, the process of generating the product image can be completed in an offline state.

In practical applications, the server 12 may generate multiple decorated product images for the product. For example, for the dress shown in FIG. 1a, the server may generate a first product image of a young female model wearing the dress at the seaside, and may also generate a second product image of a young female model wearing the dress on a campus, and so on. The multiple generated product images are all stored in association with the product. If a first female user located in Hainan accesses the product through an application, the server can obtain the first product image for displaying on a first client interface corresponding to the first female user. If a second female user located in a ** university accesses the product through an application, the server can obtain the second product image for displaying on a first client interface corresponding to the second female user.

Of course, the process of the server generating the product image can also be completed online. That is, in another specific embodiment, the server 12 may, after the first client sends a product image upload request to the server, decorate the original image of the product to be accessed by the user in real time according to the relevant information of the user of the first client, and feed back the decorated product image to the user for displaying on the first client interface on the user side. As in the embodiment shown in FIG. 1b, the first client 11 is used for, in response to an access operation of the user, obtaining relevant information of the user. The server 12 is used for determining at least one decorative material according to the relevant information of the user; generating a product image based on the at least one decorative material and the original image of the product; and sending the product image to the first client 11. The first client 11 is used for displaying the product image on an interface.

For example, the relevant information of the user includes: young female, London, UK, and the local season is summer. The server 12 can determine decorative materials such as: outdoors, young female model, summer, London Bridge, etc., according to the relevant information; then generate a product image based on these decorative materials and the original image of the product. The product image may be: a picture of a young female wearing a long dress standing on the London Bridge in summer. The user feels a sense of familiarity upon seeing this product image and will imagine herself wearing the long dress standing on the London Bridge, thereby stimulating a desire to purchase.

Further, FIG. 1c shows a schematic diagram where the e-commerce system includes a second client 13 and a server 12. The second client 13 can be understood as a client on the merchant side in the field of e-commerce. Specifically,

the second client 13 is used for, in response to an image upload request, sending an original image of a product to the server;

the server 12 is used for determining at least one decorative material suitable for the product, and generating a product image based on the at least one decorative material and the original image;

the second client 13 is used for displaying the product image so that an uploader can review and confirm whether to upload;

wherein, the product image is used for displaying when a user having a correlation with the at least one decorative material accesses the product.

Similarly, the above original image of the product may be the first image mentioned in the above embodiments; the product image may be the second image.

In this embodiment, the decorative material may include at least one of the following: a product image background material, a material displayed in combination with the product, a model type displaying the product, etc. Among them, the product image background material may include but is not limited to: a background of famous historical sites, a background of scenic spots (such as seaside, mountain peaks, etc.), an indoor background (which can be further subdivided: bedroom, kitchen, dining room, living room, etc.), a park background, a school background (which can be further subdivided: classroom, laboratory, playground, gymnasium, etc.), a grass background, a sky background, etc. Materials displayed in combination with the product will be different for different types of products. For example, for clothing products, materials displayed in combination with the product may include but are not limited to: belts, headwear, brooches, silk scarves, bags, etc. For footwear products, materials displayed in combination with them may include but are not limited to: socks, shoelaces, etc. For furniture products, materials displayed in combination with them may include but are not limited to: books on a bookshelf, ornaments, etc., cushions on a sofa, carpets, etc.; examples are not listed one by one here.

It should be added here that the server can generate multiple product images for one product, and the multiple product images use different decorative materials. For example, for one product, a merchant sells it to multiple countries through an e-commerce platform; in this way, the server can generate product images suitable for users in each country for users in different countries.

It should be noted here that the above server 11 may be a server, a service cluster composed of multiple servers, a virtual server deployed on a server or a service cluster, or a cloud, etc., which is not limited in this embodiment. Hardware devices corresponding to the first client 12 and the second client 13 may be mobile phones, computers, tablet computers, smart wearable devices, etc. Similarly, this embodiment is not specifically limited.

Specific content of functions corresponding to the above server, first client, and second client will be expanded and described in the following method embodiments.

An embodiment of the present application provides an image display method, and an execution subject of all steps in the method may be the first client in the above image processing system. Specifically, the image display method includes:

S11, in response to an operation of a user, obtaining a second image having a correlation with the user; where the second image is generated based on at least one decorative material and a first image of the target object, and the at least one decorative material has a correlation with the user;

S12, displaying the second image on a client interface.

In some implementable embodiments, the target object is associated with multiple images, and the images correspond to image tags. Correspondingly, the above S11 "obtaining a second image having a correlation with the user" may specifically include:

S111, determining a keyword according to relevant information of the user;

S112, querying at least one second image whose image tag matches the keyword among the multiple images;

where the image tag of the second image is determined by the at least one decorative material on which it is based.

In another implementable solution, the "obtaining a second image having a correlation with the user" in the above S11 may specifically include:

S111', determining the at least one decorative material according to relevant information of the user;

S112', generating a second image based on the at least one decorative material and the first image of the target object.

Further, the above decorative material may include but is not limited to at least one of the following: an image background material, a material displayed in combination with the target object, and a model type displaying the target object.

Further, the above target object may be a product on an e-commerce platform (also referred to as an online product). Correspondingly, the above first image is an image uploaded by a merchant. The image uploaded by the merchant may be a photo of a product with a solid color background, etc.

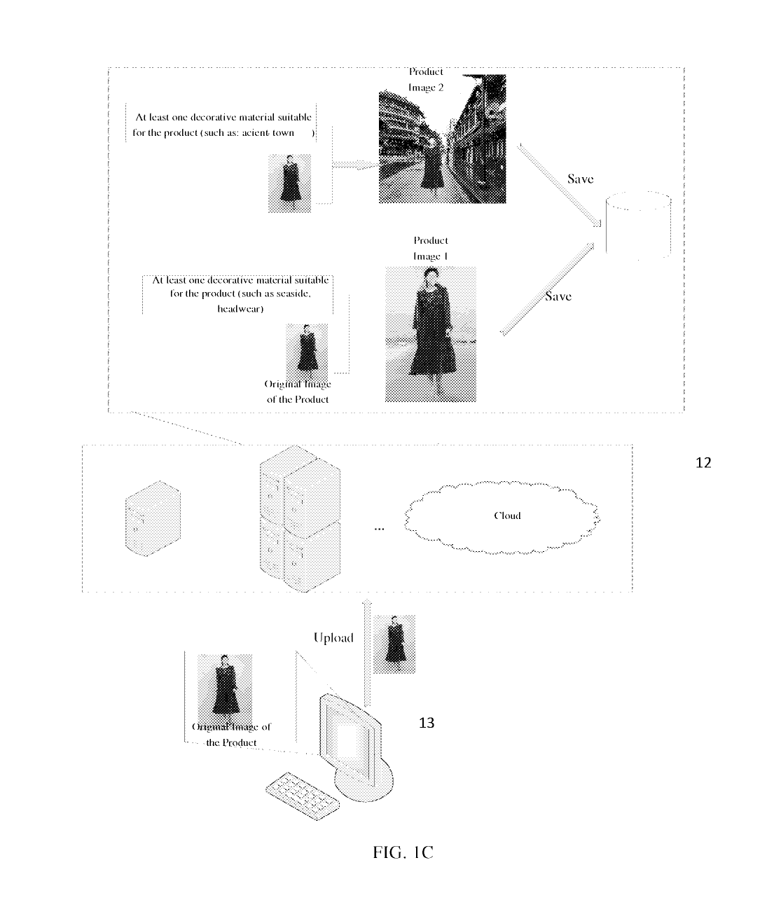

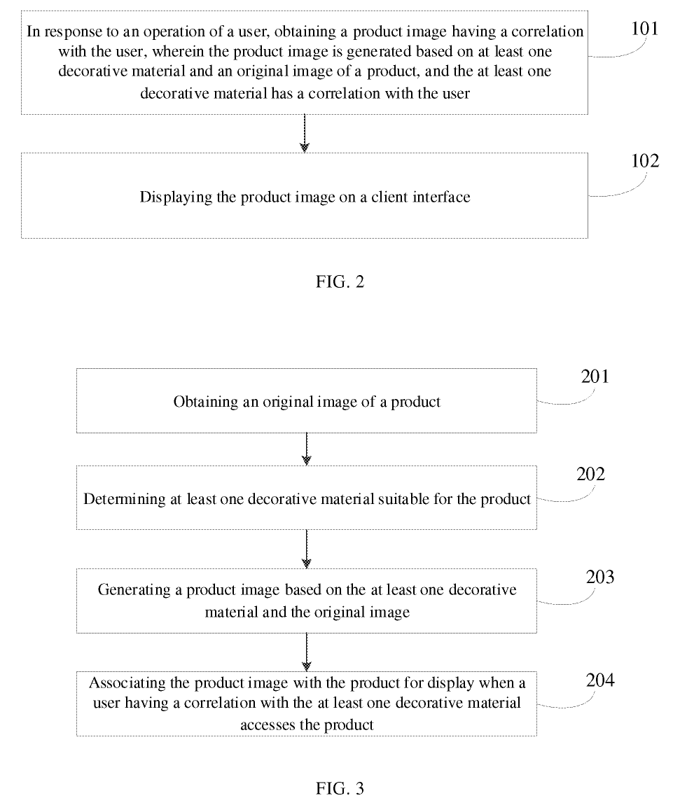

For details of the specific implementation of each step in this image display method embodiment, reference may be made to the relevant content described below in conjunction with FIG. 2.

Based on the above content, the technical solution corresponding to the image display method provided by the embodiments of the present application is described below by taking a target object being a product, a first image being an original image of the product, and a second image being a product image obtained after decorating the original image as an example. FIG. 2 shows a schematic flowchart of an image display method provided by an embodiment of the present application. The execution subject of all steps in the method described in this embodiment may be the first client in the above system. Specifically, the method includes:

101, in response to an operation of a user, obtaining a product image having a correlation with the user; where the product image is generated based on at least one decorative material and an original image of a product, and the at least one decorative material has a correlation with the user;

102, displaying the product image on a client interface.

In the above 101, the operation of the user may be an operation of the user clicking to open an e-commerce webpage or application (APP); correspondingly, the client interface is an e-commerce webpage home page or an APP home page. Alternatively, the operation of the user is an operation of inputting a product name in a search box or an input box and then clicking search; correspondingly, the client interface is a search result display page. Alternatively, the operation of the user is an operation of clicking a product category in the home page; correspondingly, the client interface is a product list page corresponding to the product category. Alternatively, the operation of the user is an operation of clicking to enter a specific product page; correspondingly, the client interface is the product page; and so on.

The above steps 101 and 102 illustrate the process of obtaining and displaying a product image of a product on the client interface. In fact, if product images of multiple products are to be displayed on the client interface, the process of obtaining and displaying the product image of each product may be the process of the above steps 101 and 102.

There may be a situation where some products correspond to product images decorated using decorative materials, but there is no correlation between the product images and the user; and/or some products do not have product images decorated using decorative materials; for these products, the original image of the product is displayed on the client interface.

The technical solution provided by this embodiment obtains a product image of a product having a correlation with a user after monitoring an operation of the user, and displays the product image on a client interface; the product image is generated based on at least one decorative material and an original image of the product, and the at least one decorative material has a correlation with the user. It can be seen that the product image displayed to the user in this solution is a decorated image that has a correlation with the user; in this way, the user can directly feel that the product is closely related to himself/herself, providing a stronger sense of immersion.

Further, the product is associated with multiple product images. Decorative materials on which each product image is based are different, with the purpose of adapting to different types of users. The multiple product images associated with the product may be generated in an offline state by the server in the above system embodiment. The execution subject of the method described in this embodiment, the first client, may periodically obtain product images of products from the server and store them locally, or synchronize them to the first client after the server updates multiple product images of a certain product; correspondingly, the execution subject of steps 1011 and 1012 below may be the first client. Alternatively, the multiple product images associated with the product are stored in the server, and the first client sends the relevant information of the user to the server, and the server queries images from the multiple product images associated with the product and feeds back a product image having a correlation with the user; correspondingly, the execution subject of steps 1011 and 1012 below may be the server.

The "obtaining a product image having a correlation with the user" in the above 101 includes:

1011, determining a keyword according to relevant information of the user;

1012, querying a product image whose image tag matches the keyword among multiple product images associated with the product;

where the image tag of the product image is determined by the at least one decorative material on which it is based. For example, for a certain product "T-shirt," the product image of the product is generated based on decorative materials "London Bridge, young female model" and a solid color background original image of the "T-shirt"; correspondingly, the image tag of the product image is determined by "London Bridge, young female model." A relatively simple implementation solution is to directly use "London Bridge, young female model" as the image tag of the product image.

Alternatively, the product image of the product is generated online, which may be that the first client determines at least one decorative material according to relevant information of the user after responding to an operation of the user, and generates the product image based on the at least one decorative material and the original image of the product; or it may be that after the first client responds to an operation of the user, it obtains relevant information of the user and sends the relevant information of the user to the server; the server determines at least one decorative material according to the relevant information of the user, generates the product image based on the at least one decorative material and the original image of the product, and feeds back the generated product image to the first client.

It should be noted here that there may be one or more product images of the product having a correlation with the user. If there are multiple images, multiple product images can be displayed in a scrolling manner on the client interface when step 102 is executed.

In addition, it should be added that the above embodiments do not describe the determination of decorative materials and the generation process of product images in detail. Content in this regard will be specifically described in the following embodiments.

Another embodiment of the present application provides an image processing method. The execution subject of the method may be a server. The execution subject of the method in this embodiment may also be a first client or a second client, or the first client and the server execute cooperatively, or the second client and the server execute cooperatively. Specifically, the image processing method includes:

S21, obtaining a first image of a target object;

S22, determining at least one decorative material suitable for the target object;

S23, generating a second image based on the at least one decorative material and the first image;

S24, associating the second image with the target object for display when a user having a correlation with the at least one decorative material accesses the target object.

Further, in an implementable solution, the above S22 "determining at least one decorative material suitable for the target object" may specifically include:

S221, determining at least one decorative material according to object information of the target object and target market information of the target object, where the target market information includes: at least one of a sales region and a target crowd; and/or

S222, determining the at least one decorative material according to material configuration information set by the first image provider.

Further, a specific implementation solution of the above S221 "determining the at least one decorative material according to object information of the target object and target market information of the product" may be implemented by the following steps:

S2211, triggering a preset analysis model so that the preset analysis model feeds back the at least one decorative material based on the object information and the target market information.

Further, in an implementable solution, the above S23 "generating a second image based on the at least one decorative material and the first image" may specifically include:

separating a target object main body from the first image; splicing the at least one decorative material as a background of the target object main body with the separated target object main body to obtain the second image; or

using the first image, regional information of a target object main body region in the first image, and the at least one decorative material as drawing materials for a preset drawing model to generate the second image.

Correspondingly, another embodiment of the present application further provides an image upload method corresponding to the above image processing method. The image upload method includes:

S31, in response to an image upload request, obtaining a first image of a target object;

S32, determining at least one decorative material suitable for the target object ;

S33, generating a second image based on the at least one decorative material and the first image;

S34, displaying the second image for an uploader to review and confirm whether to upload;

where the second image is used for display when a user having a correlation with the at least one decorative material accesses the target object.

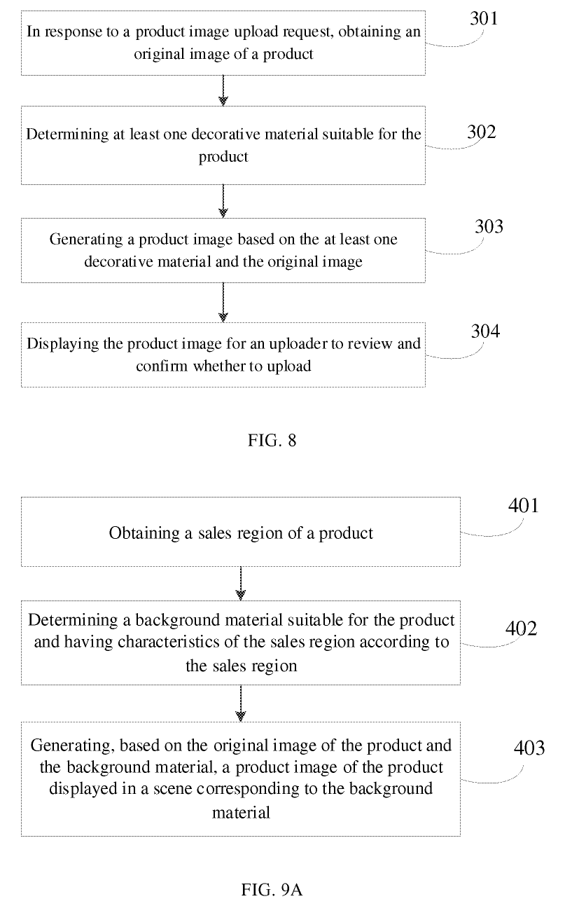

Similarly, the target object described in the above image processing method embodiment or image uploading method embodiment may be an online product. The first image may be an original image of the product, and the second image may be a product image obtained after decorating the original image. For details of the specific implementation of each step in the above image processing method embodiment, reference may be made to the relevant content described below in conjunction with FIG. 3. And for the specific implementation content of each step in the image uploading method embodiment, reference may be made to the relevant content described below in conjunction with FIG. 8.

Based on the above content, taking a target object being a product, a first image being an original image of the product, and a second image being a product image obtained after decorating the original image as an example, the image processing method and the image upload method provided by the embodiments of the present application are described in detail. Details are as follows:

FIG. 3 shows a schematic flowchart of an image processing method provided by an embodiment of the present application. The execution subject of the method may be a server, and the server may be a single server, a service cluster, a virtual server deployed on a server, or a cloud, etc., which is not limited in the embodiments of the present application. Of course, if hardware devices corresponding to the first client or the second client have strong computing capabilities, the execution subject of the method in this embodiment may also be the first client or the second client. Alternatively, the first client and the server execute cooperatively (that is, some steps are executed by the first client, and other steps are executed by the server), or the second client and the server execute cooperatively. As shown in FIG. 3, the product image processing method provided by the embodiment of the present application includes the following steps:

201, obtaining an original image of a product.

202, determining at least one decorative material suitable for the product.

203, generating a product image based on the at least one decorative material and the original image.

204, associating the product image with the product for display when a user having a correlation with the at least one decorative material accesses the product.

In the above 201, the original image of the product may be provided by a merchant. The product may be but is not limited to the following types of products: clothing, home furnishings, shoes and boots, bags (handbags, schoolbags, luggage, etc.), scarves, hats, gloves, belts, accessories (such as bracelets, rings, necklaces, earrings, headwear, etc.), watches, handheld electronic devices (such as mobile phones, laptops, tablet computers, etc.), etc. The present application mainly takes clothing as an example to introduce the technical solution provided by the present application. The original image of the product may be uploaded by the merchant through an interactive interface provided by the second client.

In the above 202, at least one decorative material can be determined based on product information of the product and target market information of the product. Here, the target market information includes: at least one of a sales region and a target crowd. The target crowd can be simply understood as: the product is suitable for young user groups, the product is suitable for male or female groups, etc. And/or the at least one decorative material is determined according to material configuration information set by the original image provider (i.e., the merchant). For example, the second client provides a material configuration function for the merchant, and the merchant can fill in or select material configuration content on a material configuration page. Material configuration items that can be filled in or selected on the material configuration page may include but are not limited to: the product is suitable for a season, suitable for a venue (office, sports field, leisure place, etc.), suitable for male or female, suitable for young/youth/middle-aged/elderly groups, materials suitable for matching, etc.

The above product information may include but is not limited to a product identifier (such as a product name), product attribute information (such as a category (such as clothing), color, material, etc.), etc. The product information may be uploaded by the merchant through an interactive interface provided by the second client; and/or obtained by the second client or the server by identifying the original image of the product through image recognition technology (such as OCR (Optical Character Recognition) technology, machine learning models, etc.); and/or the product information is obtained by the second client or the server by performing image search based on the original image of the product, etc. This embodiment does not specifically limit the manner in which product information is obtained.

The above sales region may be input by the merchant. Alternatively, it is determined by the server based on historical sales volume of the product in various regions, etc. For example, if a certain product has the largest sales volume in eastern coastal areas, the sales region of the product can be determined as the eastern coastal areas. Alternatively, the server locates an audience group of the product based on product information; and determines a region where the audience group is concentrated as the sales region of the product.

Manners of obtaining product information and sales regions are described below in conjunction with specific application scenarios.

FIG. 4 shows a specific application scenario corresponding to the solution of the embodiment of the present application, where a merchant successfully logs in to a merchant background page provided by an e-commerce platform through a second client 13, and enters a "publish product" page A as shown in FIG. 4 by clicking a "publish product" functional control on the merchant background page. Thereafter, for a product to be published, the merchant can upload an original image g of the product and input object information through the "publish product" page. After the input is completed, the merchant can click a "publish" control, and the second client 13 sends a product publication request to the server in response to the clicking operation of the merchant. After receiving the product publication request, the server can obtain the original image of the product and the object information uploaded by the merchant from information carried in the product publication request. At the same time, the second client 13 pops up a prompt box 01, in which reminder information is displayed to remind the merchant whether the original image needs to be decorated (as in FIG. 4, whether a corresponding product display effect image needs to be generated based on a sales region). A first selection control ("Yes" control) and a second selection control ("No" control) are also displayed in the prompt box 01. If the merchant clicks the first selection control, it indicates that the merchant triggers a confirmation operation for the reminder information, confirming authorization to process the uploaded original image of the product. In response to the confirmation operation, the second client 13 displays a page corresponding to an image generation service (such as page B shown in FIG. 4), and the merchant can perform a corresponding input operation on this page to input a product sales region and the like. For example, assuming that information input by the merchant in a prompt word input box 21 on page B shown in FIG. 4 is "the background is the beach by the sea", it indicates that the region the product sales is intended for is a seaside city; or, only an input box is simply displayed through the second client, and the merchant can input the sales region of the product in the input box; or, an inquiry information is output in a voice manner through the second client to inquire the merchant about the sales region of the product, so as to determine the sales region of the product based on a voice reply of the merchant to the inquiry information. If the merchant clicks the second selection control, it indicates that the merchant triggers a rejection operation for the reminder information, and after the server responds to the rejection operation, it saves the obtained original image of the product and the object information uploaded by the merchant, and ends.

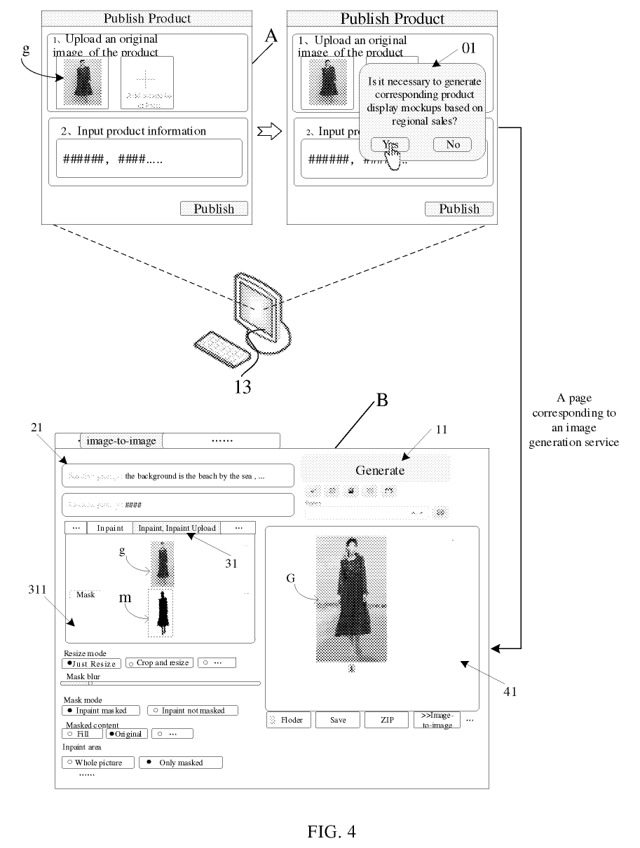

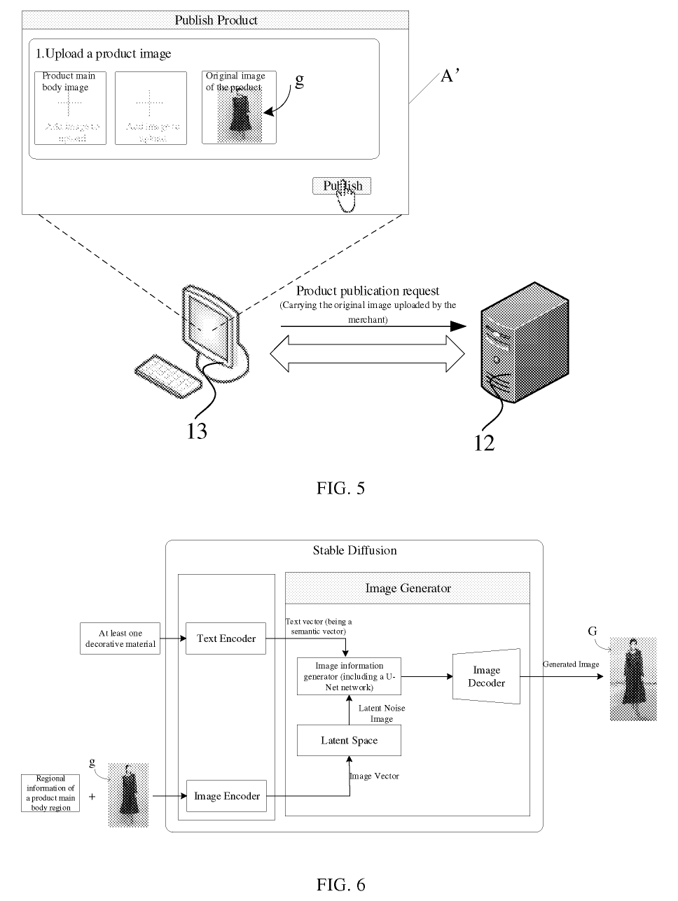

FIG. 5 shows another specific application scenario corresponding to the solution of the embodiment of the present application, where a merchant uploads an original image of a product to a server through a second client 13. Product information can be determined by the server based on the original image of the product. Specifically, as shown in FIG. 5, for a product that needs to be released, after the merchant finishes uploading the original image of the corresponding product through a "Release Product" page A' and clicks a "Release" control, the second client 13 sends a product release request to the server 12 in response to this clicking operation, and the product release request carries the original image of the product uploaded by the merchant. The original image of the product is a product main body image with a solid color background, mainly used to display product appearance and functions. After obtaining the original image of the product uploaded by the merchant from the received product release request, the server 12 can use image recognition technology to identify the product in the original image to obtain product information. Further, it can also determine a sales region suitable for the product in combination with collected historical sales information of the product or products similar to the product. Assuming that the product information obtained through recognition includes: dress, blue, gauze, etc., it can be correspondingly determined that the product is suitable for summer and young female groups. In combination with the collected historical sales information, it is analyzed that there are many young female consumers in region A, then region A can be determined as a sales region suitable for the product.

Based on the above example content, in an implementable technical solution, the method provided in this embodiment may further include the following steps:

Sa1, in response to a release operation triggered by a user for the original image of the product, outputting reminder information to remind whether the original image needs to be decorated;

Sa2, if the first user triggers a confirmation operation for the reminder information, obtaining product information of the product and target market information of the product, or displaying a material configuration page so that the original image provider sets material configuration information through the material configuration page.

Correspondingly, the above step 202 "determining at least one decorative material suitable for the product" may include:

determining the at least one decorative material according to the product information of the product and the target market information of the product, where the target market information includes: at least one of a sales region and a target crowd; and/or

determining the at least one decorative material according to the material configuration information set by the original image provider.

Further, in the above step Sa2, the product information and/or the target market information of the product may be determined by identifying a product main body in the original image of the product to determine product information; then in combination with collected historical sales information of the product or products similar to the product, a sales region suitable for the product is determined. Alternatively, the product information and/or the target market information of the product is input by the merchant (such as the original image provider) through a corresponding input page.

Using the product information and sales region obtained above, user group types, seasons, scenes (such as indoor/outdoor, indoor can be further subdivided into home, office, exhibition hall, library, shopping mall, etc., outdoor can be further subdivided into parks, community gardens, squares, scenic spots, landmark buildings, etc.) suitable for the product when sold in the sales region can be analyzed.

Specifically, the above step "determining the at least one decorative material according to the product information of the product and the target market information of the product" can be implemented using artificial intelligence technology. For example,

triggering a preset analysis model so that the preset analysis model feeds back the at least one decorative material based on the product information and the target market information.

The above preset analysis model may be a machine learning model trained with a large amount of relevant training data. For example, the machine learning model may be a natural language processing model, that is, the natural language processing model can be triggered to feedback at least one decorative material suitable for the product through an inquiry manner. That is, the above step "triggering a preset analysis model so that the preset analysis model feeds back the at least one decorative material based on the product information and the target market information" may include:

Sb1, generating an inquiry question based on the product information and the target market information;

Sb2, using the inquiry question to trigger a natural language processing model to feedback at least one decorative material suitable for the product.

In specific implementation, the above natural language processing model may be but is not limited to a ChatGPT chatbot. Taking the ChatGPT chatbot as an example, assuming that the above region is a certain region L, and the product information includes: dress, blue, cotton, etc., the generated inquiry question may be: what are the crowd types, seasons, geographical locations, and suitability for indoor or outdoor use for a cotton blue dress when facing users in region L; then, the above ChatGPT chatbot is called, and the above inquiry question is input into the ChatGPT chatbot, thereby obtaining reply information output by the ChatGPT chatbot, for example, the reply information may be "this dress is suitable for young women to wear in summer, and is very suitable for wearing on a vacation at ** beach in region L. When vacationing at the beach, wearing this dress can well adapt to the hot and humid environment of the beach."; based on the above reply information, it is determined that the at least one decorative material may include: outdoor, ** beach, young women, summer.

After determining the at least one decorative material, a product image of the product can be generated based on the at least one decorative material and the original image of the product.

The above step 203 "generating a product image based on the at least one decorative material and the original image" may include:

2031, separating a product main body from the original image; splicing the at least one decorative material as a background of the product main body with the separated product main body to obtain the product image; or

2032, using the original image, regional information of a product main body region in the original image, and the at least one decorative material as drawing materials for a preset drawing model to generate the product image.

In the above 2032, the "regional information of the product main body region in the original image" may be manually annotated or determined using image recognition technology. A region in the original image other than the product main body region is a region to be drawn, or in addition to the region other than the product main body region, a small region of the product main body region is also a region to be drawn. For example, if the product is a long dress and the at least one decorative material includes a belt, then the waist of the long dress is also a region to be drawn.

For example, as shown in FIG. 4, in addition to inputting the sales region of the product through page B, page B also provides a mask image upload interface. The merchant can upload (input) a mask image m corresponding to the original image of the product through this interface, where a white region in the mask image m is a region to be drawn, and a black region is a non-drawing region. A region in the original image of the product corresponding to the white region in the mask image m is the region to be drawn. The above mask m may be obtained by the merchant pre-processing the original image of the product with the help of tools such as PS. Alternatively, in a case where the merchant selects an image-to-image function such as local drawing for the original image of the product, the region to be drawn is a region circled (selected) by the merchant for the product image using a method such as graffiti. However, in order to ensure the accuracy of determining the region to be drawn, it is preferable to use a mask to determine the region to be drawn in the product image.

Alternatively, the region to be drawn in the original image of the product may also be determined by the server. For example, the server can use image recognition technology to identify the original image of the product to analyze the product main body region, then determine the product main body region as a non-drawing region, and determine a region in the original image of the product other than the product main body region as the region to be drawn.

Based on the above content, in a specific implementable solution, the method provided in this embodiment may further include the following steps:

Sc1, in response to a mask image upload operation of a user, obtaining a mask image corresponding to the product image; determining regional information of a product main body region based on the mask image; or,

Sc2, in response to a region selection operation triggered by the merchant for the product image, determining a selected region in the product image as regional information of a product main body region; or,

Sc3, identifying the original image of the product to identify a product main body region; obtaining regional information of the product main body region based on an identification result.

It should be added here that if there are other objects in the original image of the product used to set off the product in addition to the product main body, in order to ensure the accuracy of identification and avoid misidentifying other objects that play a setting-off role as the product main body, the original image of the product can be identified based on the obtained product information to accurately identify the product main body.

In specific implementation, the preset drawing model may be an image generation model based on artificial intelligence technology such as stable diffusion (abbreviated as SD).

Continuing to refer to FIG. 4, taking the preset drawing model being SD as an example, after the merchant uploads the mask m through page B of the second client and clicks the "Generate" control 11, the second client sends a generation request to the server in response to this clicking operation, and the generation request carries the original image g of the product, the mask m, and at least one decorative material (which can be understood as basic parameters for image-to-image). In response to the generation request, the server passes the product image g, the mask m, and the at least one decorative material to SD. Then, referring to FIG. 6, SD will execute the following steps:

1) using a text encoder (which is a special Transformer language model) to extract semantic information of at least one decorative material (i.e., the semantic vector shown in FIG. 6);

2) in order to speed up a subsequent image generation process, using an image encoder to encode and compress the original image g of the product and the regional information of the product main body region determined based on the mask m from a pixel space to a low-dimensional latent space (Latent Space) to obtain a latent image; and performing a diffusion process (Diffusion Process) by adding noise to the latent image, etc., to obtain a latent noise image. The above image encoder may be a variational autoencoder (VAE).

3) using the latent noise image obtained above and the extracted semantic information as inputs to an image information generator, where the semantic information is a control condition for the image information generator; executing the image information generator, and information output by the image information generator will be further input to a subsequent image decoder, and the image decoder uses the information output by the image information generator to perform image reconstruction, thereby generating a new product image.

It should be added here that: the merchant can also configure corresponding image generation parameters through page B as shown in FIG. 4, such as resize mode, mask blur, mask mode, masked content, inpaint area, and the like, and the server can pass the image generation parameters configured by the merchant to SD, so as to complete generation of a new product image based on the received image generation parameters. Of course, the merchant may also not configure the above image generation parameters and directly use default values.

Further, a generated display effect image corresponding to the product can also be returned to the merchant for the merchant to view, so that the merchant decides whether to adopt the product image. If the merchant triggers an adoption (confirm save) operation, the product image can be persistently maintained; conversely, if the merchant triggers a regeneration operation, the above steps can be re-executed to regenerate the product image. That is, the method provided in this embodiment may further include the following steps:

Sd1, displaying the product image of the product;

Sd2, detecting an operation triggered by the merchant for the product image;

Sd3, if a confirmation operation is detected, saving the product image in association with the product;

Sd4, if a regeneration operation is detected, re-executing the above steps 201 to 203.

FIG. 4 shows an example of displaying a generated product image G in an image display area 41 on page B corresponding to SD. If the merchant triggers a save operation for the displayed product image G, for example, the merchant clicks a "Save" icon or a "Zip" icon located under the display area 41, the product image can be saved using a Key-Value data storage form. Among them, when saving, an image tag of the product image (for example, the image tag includes but is not limited to: a product identifier, a product sales region, and a user group type) can be used as a Key (keyword), and a URL of the product image G can be used as a Value. Icons under the display area 41 represent the following functional meanings from left to right: a "folder" icon represents opening a folder where the current image is located, a "Save" icon represents downloading the current image in PNG format for saving, a "Zip" icon represents downloading the current image as a zip compressed file for saving, and ">> Send to img2img" represents using the current image as a base image (original image) for image-to-image.

In summary, the technical solution provided by this embodiment determines at least one suitable decorative material for a product, and generates a product image based on the at least one decorative material and an original image of the product; the product image is associated with the product, so that it can be displayed when a user having a correlation with the at least one decorative material accesses the product. This solution pre-decorates the original image of the product, generates a decorated product image and associates it with the product to display it to the user when a correlated user accesses the product, so that the user can directly feel that the product is closely related to himself/herself, providing a stronger sense of immersion.

Further, the method provided in this embodiment may further include the following steps:

Se1, in response to a product access request triggered by a user, obtaining relevant information of the user;

Se2, determining a keyword based on the relevant information of the user;

Se3, querying a product image whose image tag matches the keyword in an image set of the product; if found, displaying the queried product image; otherwise, displaying the original image of the product.

Assuming that a young female user in region L accesses a product (dress) through a first client, a keyword is determined as "region L, young female" according to relevant information of the young female user; then a product image having a correlation with the user is queried in an image set corresponding to the product (dress), such as a product image of a young female like herself wearing this dress on ** beach in region L in summer. The product image is displayed on a first client interface, and after seeing it, the user will feel that this dress is relatively related to herself, and will have a greater interest in purchasing.

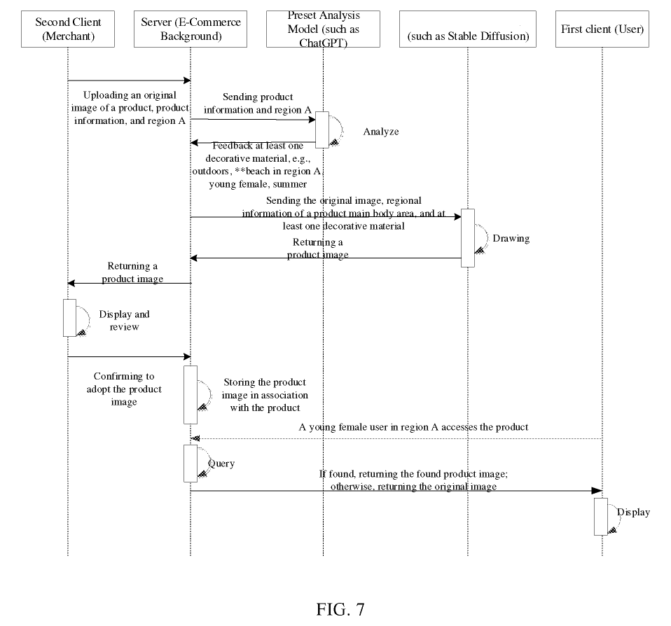

A specific solution provided in the above embodiment can be represented as a signaling diagram as shown in FIG. 7. The embodiment shown in FIG. 7 has preset that the merchant accepts the server decorating the original image of the product. Specifically, as shown in FIG. 7, the merchant uploads an original image of a product, object information, and sales region (such as region A) information to the server. After receiving the original image, the object information, and the sales region, the server triggers a preset analysis model (such as ChatGPT), so that the preset analysis model provides at least one decorative material suitable for the product (such as outdoors, ** beach in region A, young female, summer) based on the object information and the sales region. After obtaining the at least one decorative material, the server triggers a preset drawing model to use the original image of the product, regional information of a product main body area in the original image (such as a mask image), and the at least one decorative material as drawing materials for the preset drawing model, and the preset drawing model draws a product image of a young female wearing a dress (product) walking on the ** beach on a summer day. The server sends the product image to the second client. The second client displays the product image for the merchant to review. If the merchant confirms to adopt the product image, the second client sends a confirmation adoption instruction to the server, and the server stores the product image in association with the product in response to the instruction.

A young female user in region A triggers an operation of accessing the product through a first client, and in response to the operation, the first client sends a product access request to the server, where the product access request may carry a product identifier and relevant information of the user (region A, young female, etc.). After receiving the product access request, the server queries a product image in an image set corresponding to the product that has a correlation with the user (i.e., the product image of a young female wearing a dress (product) walking on the ** beach on a summer day); if found, the product image is fed back to the first client for displaying on a first client interface; otherwise, the original image of the product is returned.

Based on the content described in the present application above, another embodiment of the present application further provides a product image upload method, which is a solution corresponding to a second client side perspective. The execution subject of the method provided in this embodiment may be the second client mentioned in the above system, or some steps are executed by the second client and some steps are executed by the server. Specifically, as shown in the schematic flowchart in FIG. 8, the product image upload method includes:

301, in response to a product image upload request, obtaining an original image of a product;

302, determining at least one decorative material suitable for the product ;

303, generating a product image based on the at least one decorative material and the original image;

304, displaying the product image for an uploader to review and confirm whether to upload;

where the product image is used for display when a user having a correlation with the at least one decorative material accesses the product.

Specific implementation of the above steps 302 and 303 can refer to relevant content above, and will not be repeated here.

In the technical solution of this embodiment, after a merchant uploads an original image of a product, at least one suitable decorative material can be automatically determined for the product to generate a product image based on the at least one decorative material and the original image of the product, allowing the merchant to review and confirm whether to upload. If the merchant reviews and confirms the upload, the product image can be displayed when a user having a correlation with the at least one decorative material accesses the product on an e-commerce platform application side. The entire process only requires the merchant user to upload one original image of the product without excessive participation of the merchant, helping the merchant improve the correlation between the product image and the user and gain more attention from users.

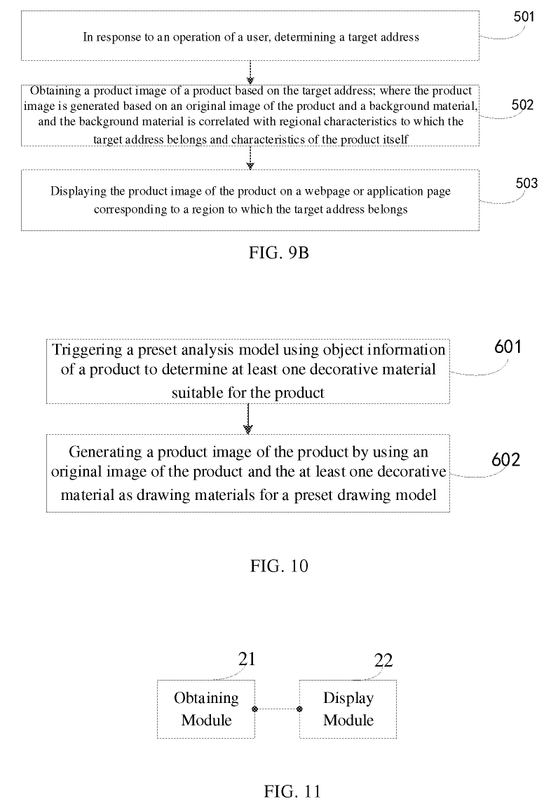

Based on the inventive idea of the technical solution of the present application, other solutions can be further extended. For example, product images displayed in webpages or application pages corresponding to different regions for the same product are different. For example, a product image with characteristics of region A is displayed in a webpage or application page corresponding to region A. For example, for the same clothing product, there is an internet-famous landmark building in region A, then the product image of the clothing displayed in the webpage or application page corresponding to region A is a street snap of a model wearing the clothing at the internet-famous landmark building. There is an ancient town in region B, then the product image is a picture of a model wearing the clothing walking in the ancient town; and so on. Thus, referring to FIG. 9a, yet another embodiment of the present application further provides a product image processing method, and an execution subject of the method may be the server in the above system. Specifically, the product image processing method includes:

401, obtaining a sales region of a product;

402, determining a background material suitable for the product and having characteristics of the sales region according to the sales region;

403, generating, based on the original image of the product and the background material, a product image of the product displayed in a scene corresponding to the background material;

where the product image is used for display in a webpage or application page corresponding to the sales region.

Further, the above 402 may specifically include:

triggering a preset analysis model, where the preset analysis model determines background material suitable for the product and having regional characteristics of the sales region according to the sales region and product information of the product.

Specifically, the background material may include, but is not limited to: outdoor backgrounds (such as grass, riverside, beach, mountain peak, residential garden, street, scenic spot, etc.), indoor backgrounds (such as bedroom, living room, office, hotel, shopping mall, etc.), objects that can be matched with the product to highlight product characteristics (such as ornaments, pendants, etc.), and so on.

Further, the method may also include: obtaining background configuration information set by a merchant, to determine the background material based on the sales region, the product information of the product, and the background configuration information set by the merchant.

When triggering the preset analysis model, a consultation question may be first generated based on the sales region and the product information of the product; the consultation question is used to trigger the preset analysis model, so that the preset analysis model provides background material suitable for the product and having regional characteristics of the sales region.

The above 403 may trigger a preset drawing model, where the preset drawing model generates a product image of the product displayed in a scene corresponding to the background material based on the original image of the product and the background material.

Relevant content regarding the preset analysis model and the preset drawing model may refer to the content above, and will not be repeated here.

The technical solution provided by this embodiment determines background material for a product that has regional characteristics of a sales region according to the sales region of the product; generates a product image of the product displayed in a scene corresponding to the background material based on the original image of the product and the background material; the product image is used for displaying in a webpage or application page corresponding to the sales region. It can be seen that the embodiment of the present application provides another new idea, where the same product has different product images for different sales regions, and the images have local characteristics; in this way, after a local user sees the product image of the product through the webpage or application page corresponding to the sales region, the user will feel that it is closely related to themselves, providing a stronger sense of immersion. There is also another possibility where a user in a first sales region can view the product image of the product through a webpage or application page corresponding to a second sales region, so as to intuitively see a scene image of the product being used in the second sales region after the user purchases the product in the first sales region, which provides a strong sense of immersion. For example, a user is going to the seaside for a vacation, and before the vacation, the user checks for long skirts suitable for a seaside vacation at their place of residence; at this time, the user can view the product image of such products through a webpage or application page corresponding to the vacation region.

For a merchant, it is the sales region of the product. For a consumer (or user), it is a positioning address (or region) or an address (or region) selected by the user. Based on the above solution, another embodiment of the present application provides a product image display method, as shown in FIG. 9b, the method comprising:

501, in response to an operation of a user, determining a target address;

502, based on the target address, obtaining a product image of a product; where the product image is generated based on an original image of the product and background material, and the background material is related to regional characteristics of a region to which the target address belongs and characteristics of the product itself;

503, displaying the product image of the product on a webpage or application page corresponding to the region to which the target address belongs;

where the target address is selected by the user or located by a user client.

The generation process of the product image and the determination of the background material in the above 502 may refer to the content in the above embodiments, and will not be repeated here.

In addition, the present application also provides a new idea, namely, an idea of using artificial intelligence technology to decorate an original image of a target object. Specifically, a preset analysis model is used to first analyze at least one decorative material suitable for the target object, and then a preset drawing model is used to generate a first image of the target object based on the original image of the target object and the at least one decorative material. Accordingly, the present application also provides an image generation method, the image generation method comprising the following steps:

S51, using object information of a target object to trigger a preset analysis model to determine at least one decorative material suitable for the target object;

S52, using the first image of the target object and the at least one decorative material as drawing material for a preset drawing model to generate a second image of the target object;

where the second image is used for display when a user having a correlation with the at least one decorative material accesses the target object.

Further, the preset analysis model is a natural language processing model. Correspondingly, in an implementable solution, the above S51 "using object information of the target object to trigger a preset analysis model to determine the at least one decorative material" may specifically include:

S511, generating a consultation question based on the object information;

S512, using the consultation question to trigger the natural language processing model to feed back at least one decorative material suitable for the target object.

Further, the method provided in this embodiment may also include the following steps:

obtaining target market information of the target object, so as to use the object information and the target market information when triggering the preset analysis model; where the target market information includes at least one of: a sales region and a target population.

The method provided in this embodiment may also include the following steps:

obtaining regional information of a target object main body region in the original image, so as to use the regional information, the original image, and the at least one decorative material as drawing material for the preset drawing model.

The target object in this image generation method embodiment may be a product on an e-commerce platform. Correspondingly, the first image may be an original image of the product, and the second image may be a product image generated after the original image is decorated.

Based on the above content, an embodiment of a product image generation method provided by the present application is described in detail by taking a target object being a product, a first image being an original image of the product, and a second image being a product image generated after decorating the original image as an example. Specifically, FIG. 10 is a schematic flowchart of a product image generation method. The execution subject of the method in this embodiment may be the server in the system mentioned above, or may be the first client or the second client. As shown in FIG. 10, the product image generation method includes:

601, triggering a preset analysis model using object information of a product to determine at least one decorative material suitable for the product;

602, generating a product image of the product by using an original image of the product and the at least one decorative material as drawing materials for a preset drawing model;

wherein, the product image is used for displaying when a user having a correlation with the at least one decorative material accesses the product.

In a specific embodiment, the preset analysis model is a natural language processing model, and correspondingly, the above 601 "using product information of the product to trigger a preset analysis model to determine the at least one decorative material" may include:

6011, generating a consultation question based on the product information;

6012, using the consultation question to trigger the natural language processing model to feed back at least one decorative material suitable for the product.

Further, the method provided in this embodiment may also include the following steps:

603, obtaining target market information of the product, so as to use the product information and the target market information when triggering the preset analysis model; where the target market information includes at least one of: a sales region and a target population; and/or

604, obtaining regional information of a product main body region in the original image, so as to use the regional information, the original image, and the at least one decorative material as drawing material for the preset drawing model.

Specific implementation regarding the above steps 601 to 604 may refer to the content above, and will not be repeated here.

The technical solution provided by this embodiment uses artificial intelligence technology to decorate an original image of a product, so that the decorated product image has a certain correlation with a visiting user, improving the user's attention to the product. That is, the product information of the product is used to trigger a preset analysis model to determine at least one decorative material suitable for the product, and then the original image of the product and the at least one decorative material are used as drawing material for a preset drawing model to generate a product image of the product; the efficiency of product image generation is improved, and it is suitable for large-batch product image processing tasks on e-commerce platforms.

The following takes overseas e-commerce as an example to describe the solution provided by the present application in combination with specific application scenarios. Specifically including:

S1. A merchant publishes a new product—a T-shirt, uploads basic information (product name and attributes) of the T-shirt and the original image (such as an image with a white background) of the T-shirt, and the merchant selects the country "United Kingdom". The second client reminds the merchant whether it is needed: whether to generate a differentiated product image based on the currently selected United Kingdom?

S2. If the merchant agrees, proceed to S3; if the merchant refuses: the process ends.

S3. The server calls a preset analysis model based on the product name and attributes and the United Kingdom selected by the merchant, and the preset analysis model provides multiple decorative materials, namely, outdoors, summer, young female, London Bridge, and the like.

S4. The server transmits the original image, information of a fixed and unchanged image area marked out, and the multiple decorative materials to a preset drawing model similar to stable diffusion, and the preset drawing model generates a picture in which a young female product subject and (outdoors, London Bridge, young female, summer) are fused, such as a product image of a young female wearing a T-shirt and running on the London Bridge on a summer day.

S5. The server returns the product image to the merchant for viewing.

S6. The second client displays the product image, and the merchant decides whether to adopt the product image.

S7. If the merchant adopts the product image, the second client triggers the server to perform saving using a product ID+country identifier+user type as a key and a URL of the product image as a value.

S8. When a young user from the United Kingdom accesses this product (T-shirt), the first client of the user triggers the server to query whether there is a corresponding product image using the product ID+country identifier+user type as a key.

S9. If there is a result in the query in step S8, the server returns the product image generated by the "merchant" for the "United Kingdom user" to the first client; otherwise, a default original image of the product is displayed.

The young user in the United Kingdom sees that the product image of this product is: a young female in summer using this product on the London Bridge, which immediately feels familiar and interesting for purchase, and the order conversion rate of the end user is improved.

Of course, the step of merchant confirmation can also be omitted. In the above product image generation steps, there are steps in which the merchant participates to obtain the confirmation right of the merchant for image modification.

Further, the technical solution provided by the present application can also be extended to another specific scenario. For example, many applications have multiple regional versions, such as a domestic version and an overseas version. If a merchant's product is sold both domestically and overseas, the merchant needs to upload the original image of the product on the domestic version application, and then the server corresponding to the domestic version application will process the original image (that is, generate a product image displayed on the domestic version application based on at least one decorative material and the original image); the merchant also needs to upload the original image of the product on the overseas version application, and the server corresponding to the overseas version application then processes the original image to generate a product image, which is a tedious operation. To this end, based on the technical solution provided by the present application, a tool can be provided for the merchant, which the merchant can call to generate product images suitable for different regional versions. Alternatively, based on the technical solution provided by the present application, an interface for uploading product images for multiple regional versions is provided for the merchant, and the merchant can complete the uploading operation for multiple regional versions through only this one interface. Specifically, the present application also provides an image display method embodiment, comprising the following steps:

701, determining a regional version of a target application;

702, based on a coverage area of the regional version, determining at least one decorative material suitable for a target object and having characteristics of the coverage area;

703, generating a second image of the target object according to a first image of the target object and the at least one decorative material;

where the second image is used for display when a user using the regional version application accesses the target object.

For example, the regional version may be a domestic version or an overseas version, and so on. The overseas version can also be distinguished into: a European and American version, an East Asian version, and so on.

The characteristics of the coverage area are related to preferences of consumers in the area, customs of consumers in the area, regional characteristics, and the like.

Several other embodiments of the present application provide devices corresponding to the method embodiments provided above from the perspective of the target object being a product. Specifically,

FIG. 11 shows a structural block diagram of an image display device provided by an embodiment of the present application. As shown in FIG. 11, the image display device includes: an obtaining module 21 and a display module 22; where the obtaining module 21 is used for obtaining, in response to an operation of a user, a product image of a product that has a correlation with the user; where the product image is generated based on at least one decorative material and an original image of the product, and the at least one decorative material has a correlation with the user. The display module 22 is used for displaying the product image on a client interface.

Further, the product is associated with multiple product images. The product images correspond to image tags. Correspondingly, the obtaining module 21 is specifically used for: determining a keyword according to relevant information of the user; querying, among the multiple product images, a product image whose image tag matches the keyword; where the image tag of the product image is determined by the at least one decorative material on which it is based.

Alternatively, the obtaining module 21 is specifically used for: determining the at least one decorative material according to relevant information of the user; generating the product image based on the at least one decorative material and the original image of the product.

It should be noted that: the product image display device provided in the above embodiment can implement the technical solution described in the corresponding method embodiment above, and the principles of specific implementation of each module or unit refer to the corresponding content in the method embodiment, which will not be repeated here.

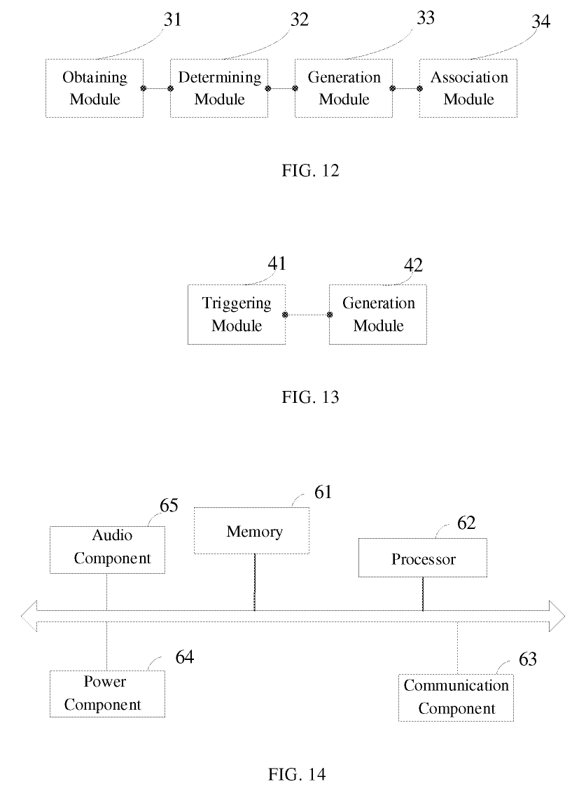

FIG. 12 shows a structural block diagram of an image processing device provided by another embodiment of the present application. As shown in FIG. 12, the image processing device includes: an obtaining module 31, a determining module 32, a generation module 33, and an association module 34. The obtaining module 31 is used for obtaining an original image of a product. The determining module 32 is used for determining at least one decorative material suitable for the product. The generation module 33 is used for generating a product image based on the at least one decorative material and the original image. The association module 34 is used for associating the product image with the product for displaying when a user having a correlation with the at least one decorative material accesses the product.

Further, the determining module 32, when determining the at least one decorative material suitable for the product, is specifically used for:

determining the at least one decorative material according to object information of the product and target market information of the product; where the target market information includes: at least one of a sales region and a target population; and/or

determining the at least one decorative material according to material configuration information set by an original image provider.

Still further, the determining module 32, when determining the at least one decorative material according to the object information of the product and the target market information of the product, is specifically used for:

triggering a preset analysis model, so that the preset analysis model feeds back the at least one decorative material based on the object information and the target market information.

Further, the generation module 33 is specifically used for:

separating a product main body from the original image; splicing the at least one decorative material as a background of the product main body with the separated product main body to obtain the product image; or

generating the product image by using the original image, regional information of a product main body area in the original image, and the at least one decorative material as drawing materials for a preset drawing model.

It should be noted here that: the product image processing device provided in the above embodiment can implement the technical solution described in the corresponding method embodiment above, and the principles of specific implementation of each module or unit above may refer to the content in the corresponding method embodiment above, which will not be repeated here.

A product image processing device provided by another embodiment of the present application includes: an obtaining module, a determination module, and a generation module. The obtaining module is used for obtaining a sales region of a product. The determination module is used for determining background material suitable for the product and having regional characteristics of the sales region according to the sales region. The generation module is used for generating a product image of the product displayed in a scene corresponding to the background material based on an original image of the product and the background material. The product image is used for displaying in a webpage or application page corresponding to the sales region.

It should be noted here that: the product image processing device provided in the above embodiment can implement the technical solution described in the corresponding method embodiment above, and the principles of specific implementation of each module or unit above may refer to the content in the corresponding method embodiment above, which will not be repeated here.

A product image uploading device provided by another embodiment of the present application includes: an obtaining module, a determination module, a generation module, and a display module. The obtaining module is used for obtaining an original image of a product in response to a product image upload request. The determination module is used for determining at least one decorative material suitable for the product. The generation module is used for generating a product image based on the at least one decorative material and the original image. The display module is used for displaying the product image, so that an uploader can review and confirm whether to upload. The product image is used for display when a user having a correlation with the at least one decorative material accesses the product.

It should be noted here that: the product image uploading device provided in the above embodiment can implement the technical solution described in the corresponding method embodiment above, and the principles of specific implementation of each module or unit above may refer to the content in the corresponding method embodiment above, which will not be repeated here.

FIG. 13 shows a structural block diagram of an image generation device provided by an embodiment of the present application. As shown in FIG. 13, the product image generation device includes: a triggering module 41 and a generation module 42. Here, the triggering module 41 is used for triggering a preset analysis model using object information of a product to determine at least one decorative material suitable for the product. The generation module 42 is used for generating a product image of the product by using an original image of the product and the at least one decorative material as drawing materials for a preset drawing model. Here, the product image is used for displaying when a user having a correlation with the at least one decorative material accesses the product.

Further, the preset analysis model is a natural language processing model. Correspondingly, the triggering module 41 is specifically used for: generating an inquiry question based on the object information; and triggering the natural language processing model using the inquiry question to feed back at least one decorative material suitable for the product.

Still further, the device provided in this embodiment further includes an obtaining module. The obtaining module is used for:

obtaining target market information of a product, so as to use the product information and the target market information when a triggering module 41 triggers a preset analysis model; where the target market information includes at least one of: a sales region and a target population; and/or

obtaining regional information of a product main body region in the original image, so as to use the regional information, the original image, and the at least one decorative material as drawing material for the preset drawing model.

It should be noted here that: the product image generation device provided in the above embodiment can implement the technical solution described in the corresponding method embodiment above, and the principles of specific implementation of each module or unit above may refer to the content in the corresponding method embodiment above, which will not be repeated here.

The device embodiments described above are merely illustrative, where the units described as separate components may or may not be physically separate, and the components displayed as units may or may not be physical units, that is, they may be located in one place, or may be distributed over multiple network units. Some or all of the modules can be selected according to actual needs to achieve the purpose of the solution of this embodiment. Those of ordinary skill in the art can understand and implement it without creative labor.

FIG. 14 shows a schematic principle structural diagram of an electronic device provided by an embodiment of the present application. The electronic device includes a processor 62 and a memory 61. Here, the memory 61 is used for storing one or more computer programs; the processor 62 is coupled to the memory 61 and used for the at least one or more computer programs to implement steps in the methods provided by the embodiments of the present application.

The above memory 61 may be implemented by any type of volatile or non-volatile storage device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or optical disk.

Further, as shown in FIG. 14, the electronic device further includes: a communication component 63, a power component 64, an audio component 65, and other components. Only some components are schematically given in FIG. 14, which does not mean that the electronic device only includes the components shown in FIG. 14.

Correspondingly, an embodiment of the present application further provides a computer-readable storage medium, on which a computer program is stored, and when the computer program is executed by a computer, the method steps or functions provided in the various embodiments of the present application can be implemented.

The methods in the present application can be implemented in whole or in part by software, hardware, firmware, or any combination thereof. When implemented using software, it can be implemented in whole or in part in the form of a computer program product. That is, the present application further provides a computer program product. The computer program product includes computer programs/instructions, and when the computer programs/instructions are executed by a processor such as the processor 62 shown in FIG. 14, the steps or functions in the methods provided by the embodiments of the present application can be executed in whole or in part. The computer may be a general-purpose computer, a special-purpose computer, a computer network, a network device, a user device, a core network device, OAM, or other programmable devices.

Through the description of the above implementation modes, those skilled in the art can clearly understand that each implementation mode can be implemented by means of software plus a necessary general-purpose hardware platform, and of course, can also be implemented by hardware. Based on such understanding, the above technical solution essentially, or the part that contributes to the prior art, can be embodied in the form of a software product, and the computer software product can be stored in a computer-readable storage medium, such as ROM/RAM, magnetic disk, optical disk, etc., including several instructions to cause a computer device (which may be a personal computer, a server, or a network device, etc.) to execute the methods described in various embodiments or some parts of the embodiments.

Finally, it should be noted that: the above embodiments are only used to illustrate the technical solutions of the present application, rather than to limit them; although the present application has been described in detail with reference to the foregoing embodiments, those of ordinary skill in the art should understand that: they can still modify the technical solutions recorded in the foregoing embodiments, or perform equivalent replacement for some of the technical features therein; and these modifications or replacements do not make the essence of the corresponding technical solutions deviate from the spirit and scope of the technical solutions of the various embodiments of the present application.

1. An image display method, comprising:
in response to an operation of a user, obtaining a second image having a correlation with the user, wherein the second image is generated based on at least one decorative material and a first image of a target object, and the at least one decorative material has a correlation with the user;
displaying the second image on a client interface.

2. The method according to claim 1, wherein the target object is associated with a plurality of images, and the images correspond to image tags;
wherein obtaining the second image having a correlation with the user comprises:
determining a keyword according to relevant information of the user;
querying, in the plurality of images, to obtain at least one second image whose image tag matches the keyword,
wherein the image tag of the second image is determined by the at least one decorative material on which it is based.

3. The method according to claim 1, wherein the obtaining the second image having a correlation with the user comprises:
determining the at least one decorative material according to relevant information of the user;
generating the second image based on the at least one decorative material and a first image of the target object.

4. The method according to claim 1, wherein the decorative material comprises at least one of: an image background material, a material displayed in combination with the target object, and a model type for displaying the target object.

5. The method according to claim 1, wherein the target object is a product on an e-commerce platform, and the first image is an image uploaded by a merchant.

6. A non-transitory computer-readable storage medium configured with instructions executable by one or more processors to cause the one or more processors to perform the method of claim 1.

7. An electronic device comprising:
one or more processors; and
one or more computer-readable memories coupled to the one or more processors and having instructions stored thereon that are executable by the one or more processors to perform the method of claim 1.

8. An image processing method, comprising:
obtaining a first image of a target object;
determining at least one decorative material suitable for the target object;
generating a second image based on the at least one decorative material and the first image;
associating the second image with the target object for displaying when a user having a correlation with the at least one decorative material accesses the target object.

9. The method according to claim 8, wherein the determining the at least one decorative material suitable for the target object comprises:
determining the at least one decorative material according to object information of the target object and target market information of the target object; wherein the target market information comprises at least one of: a sales region and a target population; and/or
determining the at least one decorative material according to material configuration information set by a provider of the first image.

10. The method according to claim 9, wherein the determining the at least one decorative material according to the object information of the target object and the target market information of the target object comprises:
triggering a preset analysis model, so that the preset analysis model feeds back the at least one decorative material based on the object information and the target market information.

11. The method according to claim 8, wherein the generating the second image based on the at least one decorative material and the first image comprises:
separating a target object main body from the first image; and splicing the at least one decorative material as a background of the target object main body with the separated target object main body to obtain the second image.

12. The method according to claim 8, wherein the generating the second image based on the at least one decorative material and the first image comprises:
generating the second image by using the first image, regional information of a target object main body region in the first image, and the at least one decorative material as drawing materials for a preset drawing model.

13. A non-transitory computer-readable storage medium configured with instructions executable by one or more processors to cause the one or more processors to perform the method of claim 8.

14. An electronic device comprising:
one or more processors; and
one or more computer-readable memories coupled to the one or more processors and having instructions stored thereon that are executable by the one or more processors to perform the method of claim 8.

15. A product image display method, comprising:
determining a target address in response to an operation of a user;
obtaining a product image of a product based on the target address; wherein the product image is generated based on an original image of the product and a background material, and the background material is related to regional characteristics of a region to which the target address belongs and characteristics of the product itself;
displaying the product image of the product on a webpage or an application page corresponding to the region to which the target address belongs;
wherein the target address is selected by the user or located by a client of the user.

16. The method according to claim 15, wherein obtaining a product image of a product based on the target address comprises:
separating a product main body from the original image; and splicing the background material as a background of the product main body with the separated product main body to obtain the product image.

17. The method according to claim 15, wherein obtaining a product image of a product based on the target address comprises:
generating the product image by using the product image and the background material as drawing materials for a preset drawing model.

18. A non-transitory computer-readable storage medium configured with instructions executable by one or more processors to cause the one or more processors to perform the method of claim 15.

19. An electronic device comprising:
one or more processors; and
one or more computer-readable memories coupled to the one or more processors and having instructions stored thereon that are executable by the one or more processors to perform the method of claim 15.
